(19) United States
(12) Patent Application Publication
(10) Pub. No.: US 2011/0215996 A1
(43) Pub. Date: Sep. 8, 2011

(54) COMPUTER AND METHOD FOR OPERATING THE SAME

(76) Inventors: Tien-Chun Tseng, TAIPEI CITY (TW); Chih-Hsiung Lin, TAIPEI CITY (TW); He-Min Li, TAIPEI CITY (TW); Hsi Chang, TAIPEI CITY (TW)

(21) Appl. No.: 13/039,321

(22) Filed: Mar. 3, 2011

(30) Foreign Application Priority Data
Mar. 8, 2010 (TW) 099106655

(51) Int. Cl. G09G 5/00

(52) U.S. Cl. 345/156

(57) ABSTRACT

A computer includes a touch element, a projection module, and a calculating element. The touch element has an operating area. When the operating area is touched, the touch element generates an input signal. The projection module is used for projecting an operating image in the operating area. The calculating element is connected with the projection module and the touch element and is used for processing the input signal to transform the input signal to a touch signal.

### CROSS-REFERENCE TO RELATED APPLICATIONS

This Non-provisional application claims priority under 35 U.S.C. §119(a) on Patent Application No(s). 099106655 filed in Taiwan, Republic of China on Mar. 8, 2010, the entire contents of which are hereby incorporated by reference.

### BACKGROUND OF THE INVENTION

1. Field of the Invention

This invention relates to a computer and a method for operating the same and, more particularly, to a computer capable of projecting an operating image for touching and a method for operating the same.

2. Description of the Related Art

To facilitate operating electronic devices by users, input interfaces are usually provided for the users to select and click icons of the electronic devices thus to input information.

At present, in the market, an input device of a computer usually has a conventional structure. Therefore, when the computer is used, external input devices are still needed to input information. For example, the computer needs a keyboard or a mouse to input information to control operation of the computer.

In addition, the input device increases the cost of the electronic devices. Further, the input device causes the electronic devices to be heavy and to occupy space, which causes inconvenience in use.

### BRIEF SUMMARY OF THE INVENTION

This invention provides a computer including a touch element, a projection module, and a calculating element. The touch element has an operating area, and when the operating area is touched, the touch element generates an input signal. The projection module is used for projecting an operating image in the operating area. The calculating element is connected with the projection module and the touch element and is used for processing the input signal to transform the input signal to a touch signal.

In one embodiment of the invention, the touch element may include a planar light generator and an image capturing element. The planar light generator projects light to form the operating area. When the operating area is touched, the light is reflected. The image capturing element captures the reflected light to generate the input signal.

This invention also provides a method for operating a computer used for a touch element. The method includes the following steps. An operating image is projected in an operating area of the touch element. When the operating area is touched, the touch element generates an input signal. The input signal is processed to be transformed to a touch signal.

The computer in the invention is operated by the touch element and uses the projection module for projecting the operating image in the operating area, and the operating area of the touch element is touched to input information. According to the invention, users input the information without using other conventional mechanical structures. Thus, manufacturing costs are saved, and the whole volume of the device is reduced.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a computer according to a first embodiment of this invention;

FIG. 2 is an operation schematic diagram according to the first embodiment of this invention;

FIG. 3 is a schematic diagram showing a computer according to a second embodiment of this invention;

FIG. 4 is an operation schematic diagram according to the second embodiment of this invention;

FIG. 5 is a schematic diagram showing a computer according to a third embodiment of this invention; and

FIG. 6 is an operation flowchart showing a method for operating a computer according to one embodiment of this invention.

### DETAILED DESCRIPTION OF THE INVENTION

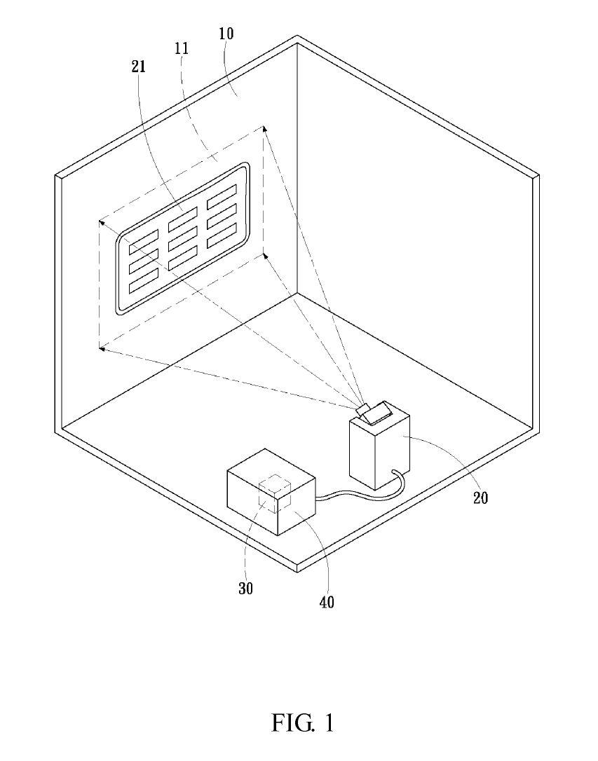

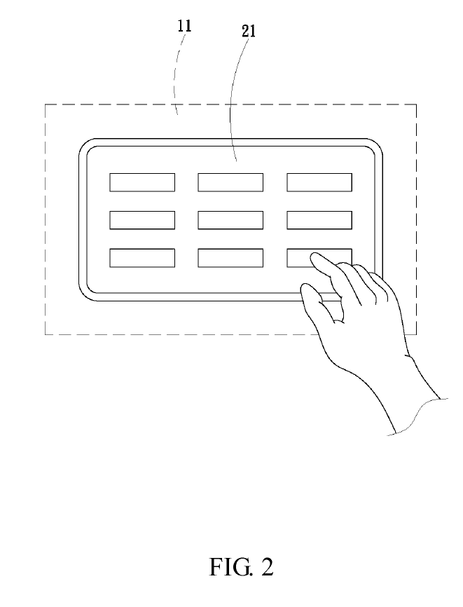

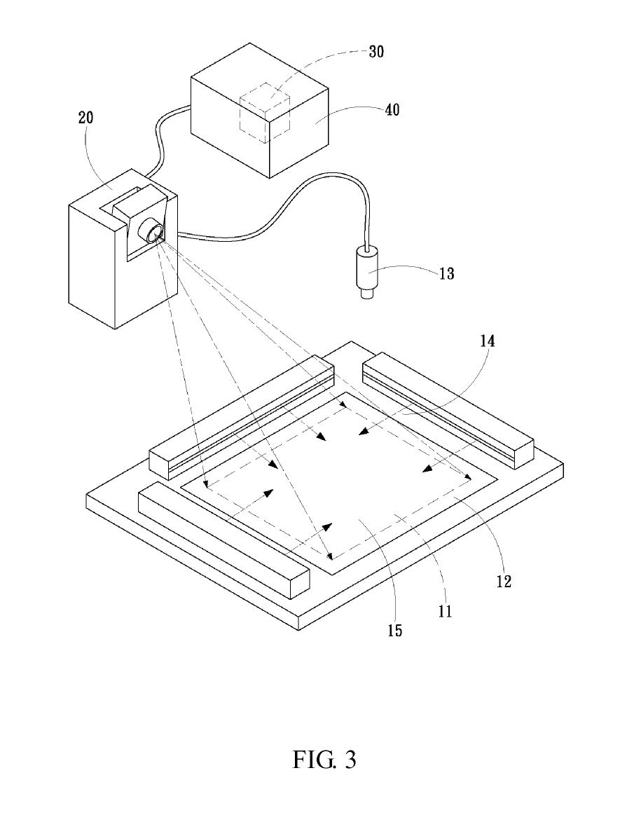

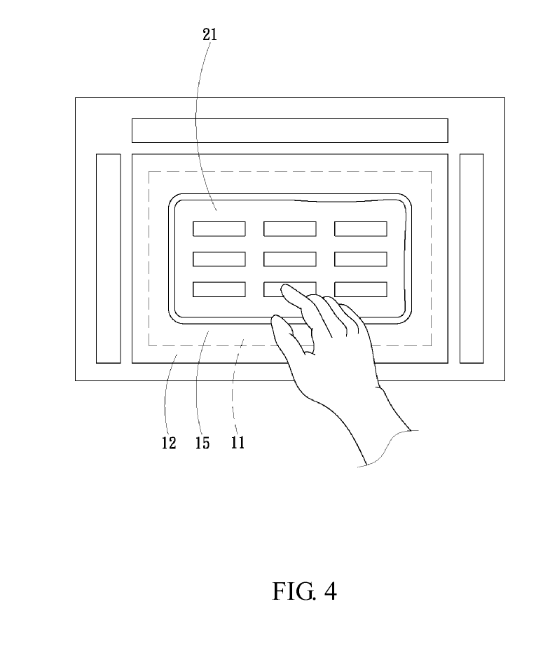

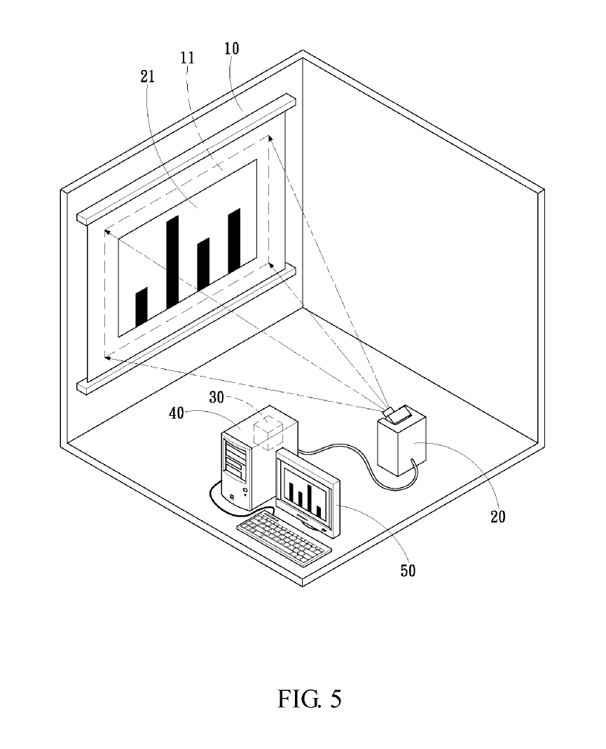

FIG. 1 is a schematic diagram showing a computer according to a first embodiment of this invention. FIG. 2 is an operation schematic diagram according to the first embodiment. FIG. 3 is a schematic diagram showing a computer according to a second embodiment of the invention. FIG. 4 is an operation schematic diagram according to the second embodiment. FIG. 5 is a schematic diagram showing a computer according to a third embodiment of the invention. In the embodiment, a computer includes a touch element 10, a projection module 20, and a calculating element 30.

In FIG. 1, the touch element 10 may be an optical touch element having an operating area 11. The operating area 11 may be disposed at any plane, such as a desktop, a screen for projecting, or a flat wall surface. The projection module 20 is used for projecting an operating image 21 in the operating area 11. The calculating element 30 is connected with the projection module 20 and the touch element 10. In the embodiment, preferably the projection module 20 may be an external projector. However, the invention is not limited thereto. In the first embodiment, the computer includes a main body 40 connected with the projection module 20. The calculating element 30 is preferably a microprocessor located in the main body 40. The main body 40 may be a computer main body or a media player. However, the invention is not limited thereto. All the devices which may be used for outputting a display signal can be used in the invention.

In FIG. 1 and FIG. 2, when a user is to operate the computer in the embodiment of the invention, the main body 40 is first started to output a display signal to the projection module 20, and then the projection module 20 is used to project the operating image 21 in the operating area 11. The user can directly touch the operating area 11 by a finger or other objects for clicking and operating the operating image 21 on the operating area 11. When the operating area 11 is touched, the touch element 10 generates an input signal. Then, the calculating element 30 processes the input signal and transforms the input signal to a touch signal.

In the embodiment, the touch signal is a number of touch points, a touch coordinate, touch time, and a touch event. For example, when the user uses a finger to touch the operating area 11, at that moment, by repeated touch of the operating area 11, the number of touch points may be record to be one or two. In addition, the touch points in the operating area 11 can be transformed to a coordinate value for displaying a correct position where the operating area 11 is touched at that moment. In addition, touch time may be recorded for recording the time points when the user touches the operating area 11.

In addition, the touch signal further includes a touch event. In the embodiment, the touch event in the operating area 11 may be pressing in the operating area 11 by the user by a finger, moving in the operating area 11 by the user by the finger, or releasing as the finger of the user leaves the operating area 11.

In the embodiment, when the calculating element 30 transforms the input signal to the touch signal, corresponding operation, such as single touch operation or multi-touch operation, is generated. For example, when a user touches the operating area 11 by a single finger, the present operation may be moving equivalent to moving of a mouse pointer, rolling equivalent to moving of a mouse roller, dragging for moving an object after the object is selected, which is equivalent to selecting the object by a mouse and dragging the object to change the original position thereof, or pressing equivalent to pressing a mouse button after the object is selected by a mouse pointer.

In addition, the multi-touch operation includes enlarging, minifying, or rotating. For example, a user may perform the multi-touch in the operating area 11 via fingers or objects and may control movement of the touch points to enlarge, minify, or rotate the display image, thus to obtain a satisfied using image of the user.

In FIG. 3, a computer in the second embodiment of the invention is shown. The difference between the computers in the second embodiment and in the first embodiment is that a touch element 10 in the second embodiment includes a planar light generator 12 and an image capturing element 13. The planar light generator 12 is rectangular. However, the invention is not limited thereto. In addition, the touch element 10 further includes the image capturing element 13. The image capturing element 13 may be a general digital camera or an IR sensor. The planar light generator 12 projects light 14 to from a light plane 15, and the light plane 15 covers an operating area 11. Thereby, a user can operate the operating area 11 by fingers or objects.

In FIG. 3 and FIG. 4, when the image capturing element 13 captures images formed by reflection of the light 14 emitted by the planar light generator 12 when the user operates the operating area 11 to touch the planar light 15 by the fingers or objects, an input signal is generated. Further, a calculating element 30 processes the input signal and transforms the input signal to a touch signal. In the embodiment, the touch signal is described as above. Therefore, it is not described for a concise purpose.

In FIG. 5, a computer in the third embodiment of the invention is shown. The difference between the computers in the third embodiment and the above embodiments is that the computer in the third embodiment includes a screen 50. The screen 50 is preferably an LCD display, and a main body 40 is connected with a projection module 20 and the screen 50 together. The main body 40 outputs a display signal to the projection module 20 for projecting an operating image 21 in an operating area 11. When a user touches the operating area 11, an input signal is processed and transformed to a touch signal via a calculating element 30, and the operating image 21 changes with the touch signal. Thereby, the display image may be shown in the screen 50 at the same time. The screen 50 as an LCD display is just taken for an example. The invention is not limited thereto. All the screens for displaying images may be used in the invention.

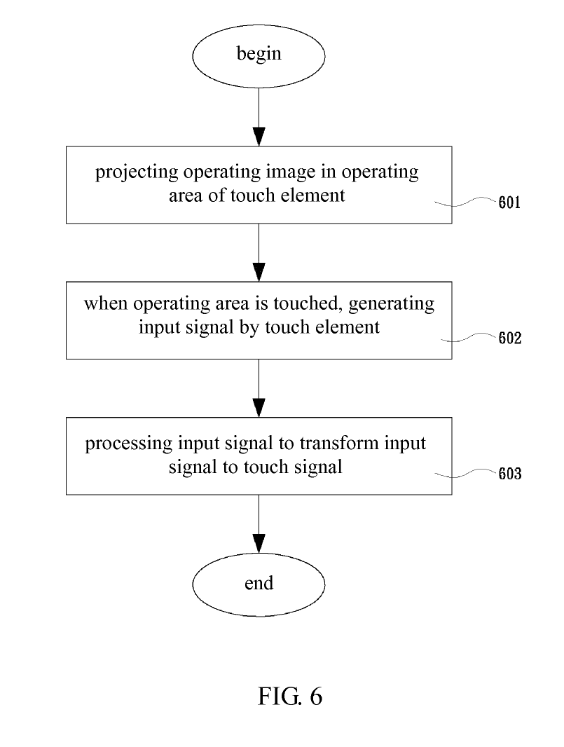

FIG. 6 is an operation flowchart showing a method for operating a computer according to one embodiment of the invention. The method is used for a touch element 10 and includes the following steps.

In step 601, an operating image is projected in an operating area of the touch element.

A user first projects the operating image 21 of the computer to the touch element 10 via a projection module 20. The touch element 10 has an area as the operating area 11. The image shown in the operating area 11 is the operating image 21, and the user touches the operating area 11 according to the corresponding operating image 21 (as shown in FIG. 1).

In step 602, when the operating area is touched, the touch element generates an input signal.

When the user operates the operating area 11, the user touches the operating area 11 by fingers or other objects. When the operating area 11 is touched, the touch element 10 receives the touch operation and generates the input signal corresponding to the touch operation (as shown in FIG. 1).

In step 603, the input signal is processed and transformed to a touch signal.

In the embodiment, the input signal corresponding to the touch operation is processed, and the input signal is transformed to the touch signal. A microprocessor is preferably used to perform the transformation. However, the invention is not limited thereto. In the embodiment, the touch signal includes a number of touch points, a touch coordinate, touch time, and a touch event.

When the user touches the operating area 11 by the fingers, at that moment, the number of the touch points in the operating area 11 may be recoded to be one or two by repeated touch of the operating area 11. In addition, during the touch operation, when the user touches any position in the operating area 11, the touch position may be transformed to a coordinate value for displaying a correct position where the user touches the operating area 11 at that moment. In addition, touch time may be recorded in the embodiment of the invention. For example, a time point when the user begins to touch the operating area 11, a time point when the user leaves the operating area 11, or time from touching the operating area 11 to leaving the operating area 11 of the user may be recorded.

The touch event is that the user performs pressing operation in the operating area 11, such as pressing down in the operating area 11 by fingers or other objects. The user may perform moving operation in the operating area 11, such as translationally sliding at any position in the operating area 11 after the operating area 11 is pressed by the fingers or other objects. Further, the user may perform releasing operation in the operating area 11. For example, the fingers or objects leave the operating area 11 after the user performs the pressing or moving operation.

According to the above, the touch signal may generate single touch operation or multi-touch operation. For example, the single touch operation may be that the user uses one finger to touch the operating area 11. At that moment, the operation performed in the operating area 11 may be moving equivalent to moving of a mouse pointer, rolling equivalent to rolling of a mouse scroll, dragging for moving an object after the object is selected, which is equivalent to dragging the object to change the original position thereof after the object is selected by a mouse, or pressing by the finger or other objects, which is equivalent to pressing a mouse button after the object is selected by a mouse pointer.

In addition, the multi-touch operation includes enlarging, minifying, or rotating. The user may multi-touch the operating area 11 by the fingers or objects and enlarge, minify, or rotate the display image according to the movement of the touch points, thus to obtain a satisfied using image of the user. For example, the user may use two fingers for touching. The display image may be enlarged according to increase of a relative distance of the two fingers in the operating area 11. The display image may be minified according to decrease of the relative distance of the two fingers in the operating area 11. The display image may be rotated according to clockwise or counter-clockwise rotation of the two fingers.

In the invention, the projection module projects the operating image in the operating area of the touch element, and the operating image of the operating area is touched to generate the input signal. Further, the different input signals are transformed to be the touch signal to achieve the operating objective. Therefore, when the computer is used, the information may be input without external operating devices.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer comprising:
a touch element having an operating area, wherein when the operating area is touched, the touch element generating an input signal;
a projection module for projecting an operating image in the operating area; and
a calculating element connected with the projection module and the touch element, for processing the input signal to transform the input signal to a touch signal.

2. The computer according to claim 1, wherein the touch element comprises:
a planar light generator projecting light to form the operating area, the light being reflected when the operating area is touched; and
an image capturing element capturing the reflected light to generate the input signal.

3. The computer according to claim 1, wherein the touch signal comprises a number of touch points, a touch coordinate, touch time, and a touch event.

4. The computer according to claim 3, wherein the touch event comprises pressing, moving, or releasing.

5. The computer according to claim 1, wherein the touch signal generates single touch operation or multi-touch operation.

6. The computer according to claim 5, wherein the single touch operation comprises moving, rolling, dragging, or pressing.

7. The computer according to claim 5, wherein the multi-touch operation comprises enlarging, minifying, or rotating.

8. The computer according to claim 1, further comprising a main body including the calculating element.

9. The computer according to claim 8, wherein the main body is connected with the projection module and outputs a display signal to the projection module to project the operating image.

10. The computer according to claim 9, further comprising a screen, the main body connected with the screen and outputting the display signal to the screen to allow the screen to display a display image.

11. A method for operating a computer used for a touch element, comprising the following steps of:
projecting an operating image in an operating area of the touch element;
generating an input signal by the touch element when the operating area is touched; and
processing the input signal to transform the input signal to a touch signal.

12. The method for operating a computer according to claim 11, wherein the touch signal comprises a number of touch points, a touch coordinate, touch time, and a touch event.

13. The method for operating a computer according to claim 12, wherein the touch event comprises pressing, moving, or releasing.

14. The method for operating a computer according to claim 11, wherein the touch signal generates single touch operation or multi-touch operation.

15. The method for operating a computer according to claim 14, wherein the single touch operation comprises moving, rolling, dragging, or pressing.

16. The method for operating a computer according to claim 14, wherein the multi-touch operation comprises enlarging, minifying, or rotating.
